(19) United States
(12) Patent Application Publication
(10) Pub. No.: US 2010/0146809 A1
(43) Pub. Date: Jun. 17, 2010

(54) CONDENSATION DRYER AND METHOD FOR THE OPERATION THEREOF

(75) Inventors: Klaus Grunert, Berlin (DE); Uwe-Jens Krausch, Brieselang (DE); Günter Steffens, Dallgow-Doberitz (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/635,776

(22) Filed: Dec. 11, 2009

(30) Foreign Application Priority Data
Dec. 16, 2008 (DE) 10 2008 054 693.3

(51) Int. Cl. F26B 3/02; F26B 25/06; F26B 19/00; F26B 21/00

(52) U.S. Cl. 34/443; 34/218; 34/88; 34/85; 34/73

(57) ABSTRACT

A condensation dryer includes a drying chamber for objects to be dried, a process air channel, a heater in the process air channel for heating the process air, a heat exchanger in the process air channel for cooling the process air after passing through the drying chamber, a fan in the process air channel for conveying the process air, a rinsing container connected to a water supply, and a controller.

### BACKGROUND OF THE INVENTION

The invention relates to a condensation dryer as well as a preferred method for the operation thereof. The invention relates in particular to a condensation dryer designed as a dryer or a washer dryer, including internal cleaning of a component arranged within a process air channel.

A condensation dryer, the mode of operation thereof being based on the condensation of moisture from the laundry evaporated by means of warm process air, requires no exhaust air pipe and is very popular, as it may be used in an internal bathroom or utility room of a larger housing complex. In a condensation dryer (also shortened hereinafter to “dryer”) air (so-called process air) is conveyed by a fan over a heater into a drum as a drying chamber containing damp laundry items. Damp laundry items to be dried are located in the drum. The hot air absorbs moisture from the laundry items to be dried. After passing through the drum, the now damp process air is fed into a heat exchanger, upstream of which a lint filter is generally arranged. In this heat exchanger (for example an air/air-heat exchanger or heat sink of a heat pump) the damp process air is cooled so that water contained in the damp process air is condensed. The condensed water (condensate) is then generally collected in a suitable container and the cooled and dried air supplied to the heater again and subsequently to the drum.

Pieces of lint contained in the laundry items to be dried, which are small suspended fabric particles, are carried along by the process air when passing through the drying chamber. Larger pieces of lint are retained in a lint filter. A portion of the fine particles of lint, however, passes through the lint filter, and is deposited downstream of said lint filter in the process air channel. The depositing of lint is particularly pronounced in the heat exchanger where condensate is located, due to the cooling of the warm, damp process air, and dampens the lint so that the lint really adheres. The lint deposited on the heat exchanger represents a hindrance for the process air flowing through the heat exchanger, and impairs the heat exchange, so that the efficiency of the condensation dryer is reduced and the susceptibility to breakdown thereof may increase.

Frequently, the heat exchangers are removable, in particular air/air-heat exchangers, so that they may be removed from the condensation dryer for cleaning and after removing lint which adheres, for example by rinsing with a rinsing fluid such as water, may be inserted again into the dryer. This is, however, not necessarily possible if a heat sink of a heat pump is used as a heat exchanger. The components of a heat pump are generally fixedly connected to one another and not removable from the condensation dryer in a reversible manner. This applies, for example, to the components of a compressor heat pump, as said components are combined in a completely sealed coolant circuit which is not easily removable. It also applies to the components of a thermoelectric heat pump which, with the inclusion of Peltier elements in which the Peltier effect occurs which causes the pumping of the heat, forms a compact subassembly which is only able to be removed again with difficulty. It may also apply to other heat pumps, for example adsorption heat pumps and heat pumps which utilize a regenerative gas circuit.

For a heat exchanger of a condensation dryer, therefore, determining a cleaning requirement, as well as the cleaning per se, are associated with an increased cost for the user. However, if cleaning of the heat exchanger is not carried out in good time, it may lead to the impairment of the performance of the condensation dryer or even to a fault leading to breakdown of the condensation dryer, so that a repair may be required. Measures for the internal cleaning of a dryer, therefore, in particular the internal cleaning of a heat exchanger are known, the condensate produced in the condensation dryer being frequently used for cleaning.

DE 10 2006 006 080 A1 discloses a cleaning device for a component arranged within a process air circuit of a domestic laundry dryer, in particular for a heat exchanger, with a channel region of the process air circuit which may be flooded via an inlet with a cleaning fluid for cleaning the component, which after completing the cleaning process may be discharged through a locking member, an excitation device being associated with the channel region with which the cleaning fluid may be set in motion.

DE 199 43 125 A1 discloses a method for cleaning a portion of a guide of a process air flow in a domestic laundry dryer in which, separately from a drying phase in which the process air flow is produced by means of a fan and is brought into contact with the laundry to be dried in a drying chamber, in a cleaning phase when the fan is switched off, a portion of the process air guide is at least partially flooded with a fluid for a specific time period, which is removed at the end of the cleaning phase from the flooded portion of the process air guide. Preferably, condensate from a heat exchanger located downstream of the drying chamber in the process air flow direction for condensing the moisture in the process air is used for the flooding in the cleaning phase.

DE 37 38 031 C2 discloses a method and a device for removing lint from a condensate water-separator formed as a heat exchanger. At least one process air channel is hermetically sealed against the coolant and designed for discharging the condensate, which is collected in a collecting container arranged below the heat exchanger until emptied. In the method, at least one inner surface of the process air channel is rinsed with at least one part of the collected condensate during a program section of limited duration. In the device, the heat exchanger is provided with a rinsing device which has at least one nozzle oriented toward at least one inner surface of the process air channel. Preferably, the collecting container has a bottom drain which is connected via a controllable valve to the rinsing device.

WO 2008/077708 A1 discloses a method for removing lint from a heat exchanger of a domestic appliance as well as a corresponding domestic appliance, for which a rinsing fluid formed, in particular, by a condensate produced during a drying process in the domestic appliance is deflected during a cleaning phase depending on the strength of an air flow, and runs through various regions of the heat exchanger depending on the deflection. Thus efficient cleaning of the heat exchanger may be achieved but only with a sufficiently large volume of rinsing fluid and/or with sufficiently rapidly flowing rinsing fluid. How this may be achieved is left open.

Finally, WO 2008/119611 A1 discloses a method and a device for cleaning a component arranged within a process air circuit of a washer dryer or laundry dryer, in particular a vaporizer of a condenser device, by means of condensate, which is obtained in the process air circuit from the damp laundry and collected in a condensate tank, from which it is supplied to a rinsing container provided above the vaporizer. On the outlet side thereof, the condensate is dispensed onto the aforementioned component by sudden opening of the relevant rinsing container.

DE 42 12 965 A1 discloses a condensation dryer with a drum and a condensation water container located within a process air flow, which has a temperature-controlled cooling circuit with a pump and a water inlet and water outlet. The water container contains at least one condensation filter element, which is arranged above the water level within the process air and in the operating range of spray nozzles of the cooling air circuit. In the embodiment of FIG. 1, the cooling water located in the water container is continuously pumped around by the pump and a three-way valve during the drying process, spray nozzles ensuring a uniform water film on the condensation filter elements, with the simultaneous rinsing and/or flushing out of the lint. For maintaining the function of a condensation water container the temperature of the water also used for rinsing has to be monitored.

DE 10 2006 018 469 A1 discloses a dryer for laundry, in which the removal of moisture from the air conveyed in air circulation operation takes place by condensation on a cooler, which is part of a heat pump, the dryer comprising a device for flooding, spraying, flowing through and/or flowing over the condenser and/or compressor, a filter filtering the water used for flooding, spraying, flowing through and/or flowing over. For the flooding it is necessary to fill the collecting container with a specific quantity of water, which is sufficient to flood both heat exchangers.

DE 10 2007 024 438 A1 discloses a domestic appliance for treating laundry items with a dryer part which may be cooled by cooling air, which comprises a condenser which comprises a hollow body through which damp process air comprising lint may flow substantially from bottom to top and through which condensate fluid may flow from top to bottom. The condenser comprises a constriction which is configured to prevent condensate fluid running down the inner walls of the hollow body from running down in an unobstructed manner under the action of the process air flowing in the opposite direction by approximately cylindrical eddying, lint filtering being produced by means of the interaction between the eddying and the flowing process air. Via a supply channel, an external rinsing fluid may be passed into the inside of the hollow body, the rinsing fluid being able to originate from a fluid collection device, which is preferably arranged in the process air guide of the washer dryer in the direction of flow of the process air upstream of the condenser to be flowed-through. During the drying process, rinsing fluid is only supplied via the supply channel in defined quantities when no, or insufficient, formation of turbulence and/or eddying is detected via a sensor.

DE 197 04 420 A1 discloses a method for monitoring the air cooled heat exchanger in an electric condensation tumble dryer, which contains air channels for the process air and for the cooling air. The drying cycles are counted and when a predetermined and/or established number of drying cycles is reached a display device is activated by triggering a switching action.

DE 37 38 033 A1 discloses a device for monitoring the degree of flooding of a condensate water-separator configured as a heat exchanger, in a domestic laundry dryer, in which the process air loaded with lint is conducted through the process air channels, which are hermetically sealed relative to cooling channels, but have good thermal contact with the coolant. One respective temperature sensor is arranged for the coolant at the inlet of the cooling channels into the heat exchanger and at the other outlet from the heat exchanger, and connected in a comparator circuit, in which the difference of the electrical values equivalent to the measured temperatures may be compared as a difference signal with an electrical reference signal. When the value of the difference signal falls below the value of the reference signal, a switching action may be triggered.

When cleaning a heat exchanger in a dryer, it may occur as a result of the method that due to light loading with laundry items to be dried and/or a small quantity of moisture in the laundry items, too little condensate is present for sufficient rinsing of the heat exchanger. A further drawback with repeated rinsing with condensate during a drying cycle is that the contamination with lint, etc. which is repeatedly found during the rinsing of the heat exchanger in the water of the condensate tank, has to be filtered out and disposed of before the next rinsing of the heat exchanger. This may be achieved by rinsing taking place using mains water instead of condensate. In other words, the dryer is provided with a water connection. A problem then is that the quantity of water required for achieving optimal cleaning results may not be adjusted, generally due to the low water pressure which prevails in many countries.

### BRIEF SUMMARY OF THE INVENTION

It is an object of an exemplary embodiment of the present invention to provide a condensation dryer in which a component arranged in the process air channel, in particular a heat exchanger, may be easily cleaned. Preferably, the cleaning is intended to be able to be undertaken automatically or in a manner which is controllable by a user.

An exemplary embodiment of the invention is a condensation dryer that includes a drying chamber for objects to be dried, a process air channel in which a heater for heating the process air, a heat exchanger for cooling the process air after passing through the drying chamber and a fan for conveying the process air are located, a rinsing container and a control device, the rinsing container being provided with a connection to a water supply.

The term “water supply” is generally understood here to be a water supply with mains water available in households, which is normally provided at a mains water pressure of at least 3 bar, occasionally however also at a higher pressure, such as for example at 6 bar.

The rinsing container generally contains an aqueous rinsing fluid provided for cleaning a component in the process air channel (also shortened hereinafter to “rinsing fluid”). The rinsing fluid generally comprises condensate and/or mains water from the water supply. For improving the cleaning action, additives such as other solvents (for example alcohol) or surface active agents may be added to the rinsing fluid. The rinsing container may also be part of a larger collecting container for aqueous fluid, the part of the collecting container containing the rinsing fluid thus also being able to be denoted as the rinsing chamber. When “rinsing container” is mentioned hereinafter, both possibilities are intended to be understood.

The condensation dryer according to an exemplary embodiment of the invention may not only be designed simply as a dryer but also as a washer dryer. Washer dryer is in this case understood as a combination appliance, which has a washing function for washing laundry and a drying function for drying damp laundry. A washer dryer is advantageous in that, as such, a water supply is already connected.

An exemplary embodiment of the invention permits the rinsing fluid to be able to be used at a uniform, fixedly predetermined pressure for cleaning components in the process air channel, irrespective of the quantity of condensate which is possibly present. By a simple method step, namely by a surge-like discharge of the rinsing fluid present in the rinsing container, the relevant component, in particular a heat exchanger, may be cleaned. A component arranged within a process air channel of a washer dryer or dryer may thus be cleaned more efficiently than previously known, in particular of lint, which has collected there during a drying cycle of damp laundry. If a quantity of rinsing fluid of, for example, 2.5 liters is assumed, which is collected in the rinsing container, an efficient cleaning of the component and/or heat exchanger is achieved in that said quantity of rinsing fluid is discharged within 1 to 2 seconds. In the case of the discharge of 2.5 liters of rinsing fluid within 1 second this corresponds to a flow velocity of 150 liters of rinsing fluid per minute. For such a flow velocity—should it be desired to use a pump to achieve this—a relatively large-volume and powerful feed pump would have to used, the use thereof however in washer dryers or dryers not being able to be considered for the supply of condensate for cleaning components arranged inside the process air channels and namely in particular heat exchangers. Alternatively, cleaning with fresh water from the water supply could be considered by using the internal pressure in this water supply. From experience, however, the pressure in a public water supply is constant neither over time nor from place to place. Thus it is not able to be automatically assumed that a corresponding cleaning device could function faultlessly at every location or at all times.

The rinsing container used in the dryer according to an exemplary embodiment of the invention preferably has a closure part at an outlet region for the rinsing fluid, as a result of the sudden opening thereof the rinsing container permitting the rinsing fluid contained therein to be discharged in a surge-like manner through a downpipe onto the aforementioned component.

Preferably, the closure part of the rinsing container is connected to a bistable spring arrangement which may be actuated for opening the outlet region of the rinsing container closed by the closure part. This has the advantage that the closure part of the rinsing container may be particularly reliably opened by the bistable action of the spring arrangement. The relevant opening may thus preferably take place particularly rapidly, as the relevant bistable spring arrangement is provided with a spring function for switching into its respective bistable position. For actuating the bistable spring arrangement, preferably a thermorelay or magnetic relay is provided coupled thereto. This has the advantage that a particularly small amount of expenditure is sufficient for activating the bistable spring arrangement.

According to an advantageous embodiment of the present invention, in a heat exchanger forming the aforementioned component, the rinsing fluid is discharged to a heat exchanger region preferably merely located at a specific distance from the inlet region of the process air into the heat exchanger. This has the advantage that deposits in the form of lint which are generally increasingly produced in the entire inlet region of the heat exchanger may be effectively removed. Thus the discharge of the rinsing fluid is preferably carried out directly or shortly after finishing a drying cycle of laundry to be dried, as at this time soiling, in particular lint adhering to the component and/or heat exchanger, is still damp or solubilized and relatively easily removable by the discharged rinsing fluid. At this time, moreover, the condensate tank and/or rinsing container are generally filled with condensate which may be used for cleaning the component, for example a heat exchanger. Moreover, generally after each drying cycle a longer time passes until the next drying cycle so that sufficient time remains for removing the rinsing fluid.

According to a further advantageous embodiment of the present invention, in a heat exchanger forming the aforementioned component the rinsing fluid is supplied by mechanical, hydraulic, pneumatic or electromechanical deflection of a starting region provided at the inlet region of the process air into the heat exchanger, as far as an end region located at a distance therefrom in the direction of the outlet region of the process air from the heat exchanger. This has the advantage that the component to be cleaned, in this case in particular a heat exchanger, may be cleaned in a relatively simple manner via a specific region. The relevant region may thus extend from the inlet region of the process air into the heat exchanger as far as the outlet region thereof from the heat exchanger. The supply of rinsing fluid is also in this case preferably carried out directly or shortly after finishing a drying cycle of damp laundry to be dried, as at this time, soiling, in particular lint adhering to the aforementioned component, is still damp and able to be easily removed by the rinsing fluid discharged in a surge-like manner.

Preferably, the rinsing container for the aqueous rinsing fluid includes a lower container opening and a cleaning line is arranged between a heat exchanger and the rinsing container.

The rinsing container is preferably a storage container for condensate, which after its formation in the heat exchanger by cooling warm, damp process air is initially collected in a condensate tank, and is then conveyed to a storage container (condensate container). Quite particularly preferably, therefore, the rinsing container is connected to a condensate tank via a condensate channel in which a condensate pump is located. The rinsing container may be installed fixedly or removably in the condensation dryer.

Between the rinsing container and the connection to a water supply or between the connection and the water supply, advantageously a valve may be arranged which is designed as a two-way valve, which may regulate the supply of water to the rinsing container or, as a three-way valve, may also provide a means for pumping out condensate provided with lint.

Expediently, therefore, in the dryer according to an exemplary embodiment of the invention, condensate which is possibly present is pumped into the rinsing container by means of a pump, from the condensate tank which is generally arranged below a heat exchanger. As a result, the condensate is provided in a relatively simple manner. Thus advantageously a relatively small, low-powered pump is used, in order to pump the condensate from the condensate tank into the rinsing container. The power of such a pump is, in particular in terms of order of magnitude, markedly less than the power of a pump as mentioned in the introduction in connection with the principal embodiment of the present invention.

This has the advantage of a low appliance cost for particularly efficient cleaning of a component arranged within a process air channel of a washer dryer or dryer. By sudden opening of the rinsing container, in particular, the condensate collected in the rinsing container, possibly topped up with a quantity of mains water from the water supply, is discharged efficiently and rapidly as a water surge to the component to be cleaned, without additional devices being required.

In the condensation dryer according to an exemplary embodiment of the invention at least one heat exchanger is present in the process air channel. The heat exchanger is, in particular, an air/air-heat exchanger or a heat sink of a heat pump. In a condensation dryer provided with a heat pump, the cooling of the warm process air loaded with moisture substantially takes place in the heat sink of the heat pump, where in the case of a compressor heat pump the transmitted heat is used for evaporating a coolant circulating in the heat pump. The coolant which is evaporated due to heating is supplied via a compressor to the condenser of the heat pump, which forms the heat source of the heat pump and where, due to the condensation of the gaseous coolant, heat is released which is used for heating up the process air before entry into the drum. From the condenser, the coolant flows through a throttle back to the evaporator, whereby the circuit is closed.

In the process air channel, therefore, a heat exchanger is preferably located as a component to be cleaned, in particular an air/air-heat exchanger or a heat sink of a heat pump.

Preferably, the condensation dryer according to an exemplary embodiment of the invention has a means for identifying a cleaning requirement for a heat exchanger, preferably as a component to be cleaned according to the present invention.

In a preferred embodiment, the condensation dryer has means for identifying a cleaning requirement for the heat exchanger which, for determining the cleaning requirement for the heat exchanger, determine an operating measure U, compare said operating measure with a predetermined value Uₗᵢₘ and when reaching Uₗᵢₘ, i.e. subject to the condition Uₗᵢₘ=U, establish the cleaning requirement.

In a preferred embodiment of the condensation dryer according to the invention, a counter is present as means for identifying the cleaning requirement, which determines the number n of drying cycles already carried out and compares with a predetermined limit number nₗᵢₘ. This counter may preferably be reset, when the cleaning of the heat exchanger is carried out.

In a further preferred embodiment of the condensation dryer according to the invention, a clock is present as means for identifying the cleaning requirement which determines a total duration tₛᵤₘ of previously carried out drying cycles and compares them with a predetermined duration limit tₗᵢₘ. This clock may preferably be reset when the cleaning of the heat exchanger is carried out.

Optionally, in a further preferred embodiment the condensation dryer according to the invention includes an evaluation unit as means for identifying the cleaning requirement, which determines a total quantity M of previously dried laundry items and compares them with a predetermined total quantity limit Mₗᵢₘ. The value of the total quantity M may preferably be reset when the cleaning of the heat exchanger is carried out.

Moreover, in a further preferred embodiment the condensation dryer includes a sensor for volumetric flow rate measurement as means for identifying the cleaning requirement in the process air channel. The evaluation unit, which determines a total volumetric flow rate V and compares said total volumetric flow rate with a volumetric flow rate limit Vₗᵢₘ, triggers the cleaning process. The value V is then preferably reset.

Finally, by means of the evaluation unit in a further preferred embodiment a temperature gradient ΔT may be determined via a temperature sensor arranged downstream of the heater viewed in the direction of the process air flow. This temperature gradient is compared with a temperature gradient limit ΔTₗᵢₘ and when exceeding the temperature gradient limit, the cleaning process is triggered.

It is preferred according to an exemplary embodiment of the invention that the condensation dryer comprises an acoustic and/or optical display means for displaying the cleaning requirement.

After determining the cleaning requirement for the heat exchanger, the cleaning of the heat exchanger is preferably carried out. Cleaning by using a rinsing fluid may be carried out automatically or by a user of the condensation dryer in a controllable manner. Preferably, to this end the condensation dryer may be adjusted as to whether cleaning is to be carried out automatically or manually.

An exemplary embodiment of the invention further relates to a method for operating a condensation dryer comprising a drying chamber for objects to be dried, a process air channel, in which a heater for heating the process air, a heat exchanger for cooling the process air after passing through the drying chamber and a fan for conveying the process air are located, a control device, a rinsing container with an aqueous rinsing fluid and a connection to a water supply, the heat exchanger being cleaned by a predetermined quantity of rinsing fluid.

In a preferred embodiment of this method, a required quantity of rinsing fluid depending on a predetermined cleaning program is determined, with which the quantity of rinsing fluid present in the storage container is compared and, when this falls below the required quantity, the rinsing container is topped up with water from the water supply to the required quantity.

A method according to an exemplary embodiment of the invention for operating a condensation dryer preferably uses a condensation dryer comprising means for identifying a cleaning requirement for the heat exchanger, said means for identifying the cleaning requirement for the heat exchanger preferably determining an operating measure U, comparing said operating measure with a predetermined value Uₗᵢₘ and when reaching Uₗᵢₘ i.e. subject to the condition Uₗᵢₘ=U, establishing the cleaning requirement.

The type and value of the operating measure U as well as the predetermined value Uₗᵢₘ, depend on the type of means used. If the means is a counter, the operating measure U generally is a natural number, which is increased by the value of one with each drying program carried out. Accordingly, when using a counter the predetermined value Uₗᵢₘ is generally also a natural number. Where U=Uₗᵢₘ, a cleaning requirement is established and generally the method according to the invention is initiated.

Accordingly, the measured value U and the predetermined value Uₗᵢₘ are respectively a time period ΔT when using a clock and respectively a weight when using a specific total quantity M of previously dried laundry items.

In the method according to an exemplary embodiment of the invention, it is preferred that the cleaning requirement for the heat exchanger preferably to be cleaned is displayed acoustically and/or optically. As it is possible, as a result, for a user of the condensation dryer to identify the cleaning requirement, an acoustic and/or optical display of the cleaning requirement in addition to automatic cleaning also permits a control of the cleaning by the user.

In the method according to an exemplary embodiment of the invention it is quite particularly preferred that the rinsing fluid comprises condensate. In this connection it is again preferred that the rinsing fluid is conducted from the rinsing container into the heat exchanger, subsequently collected in a condensate tank and pumped back again into the rinsing container. In the method it may be predetermined that such a cycle is carried out more than once.

The control device may even carry out an automatic cleaning at night time, when in any case the user does not use the dryer. At any rate, the dryer may display an existing cleaning phase and possibly indicate to the user that a condensate container used as a rinsing container is not to be emptied, so that sufficient condensate is available for cleaning.

In a preferred embodiment of the method according to an exemplary embodiment of the invention, in which the cleaning is carried out by a user of the condensation dryer, the rinsing container is filled up to a specific water quantity (for example 3 liters), for example by adding mains water from the water supply. The added water quantity is dependent on whether the rinsing container is used for storing condensate and possibly already contains condensate. Then, for example, a cleaning program is selected by the user on the condensation dryer. Via the control device, therefore, one or more cleaning steps are initiated. The start and end of the cleaning steps are preferably acoustically and/or optically displayed to the user. After completing the cleaning steps and possibly pumping back the used rinsing fluid, depending on the soiling of the used rinsing fluid and in the event of a removable rinsing container, the user may manually dispose of the rinsing fluid by removal and emptying. Alternatively, the rinsing fluid may be automatically disposed of from the condensation dryer via a discharge pipe.

An exemplary embodiment of the invention has the advantage that in a condensation dryer, irrespective of the presence of condensate and/or a sufficient quantity of condensate, a cleaning of components in the process air channel may be carried out in a simple and efficient manner. Thus, the heat exchanger of the condensation dryer may be cleaned automatically or by the intervention of a user. In embodiments of the invention, a cleaning requirement of a heat exchanger may be determined without the additional necessity of opening the condensation dryer. The invention is, in particular, advantageous when using a heat pump, as the heat sink of a heat pump generally may not be removed from the condensation dryer for cleaning. The heat exchanger of the condensation dryer may also be easily and readily cleaned without mechanical intervention on the appliance. For cleaning, neither brushes, filters or the like are required. As the invention permits regular cleaning of the heat exchanger according to requirements, a dryer with improved efficiency and a markedly reduced susceptibility to breakdown is possible.

### BRIEF DESCRIPTION OF THE DRAWINGS

Further details are revealed from the subsequent description of two non-limiting exemplary embodiments of the condensation dryer according to the invention and a method for the operation of said condensation dryer. Thus reference is made to FIGS. 1 and 2, in which:

FIG. 1 shows a vertical section through a condensation dryer which is designed as a vented dryer,

FIG. 2 shows a vertical section through a condensation dryer, which is designed as a circulating air dryer, and

FIG. 3 shows a sketch of the cleaning device used in said dryers.

### DETAILED DESCRIPTION OF EXEMPLARY EMBODIMENTS OF THE PRESENT INVENTION

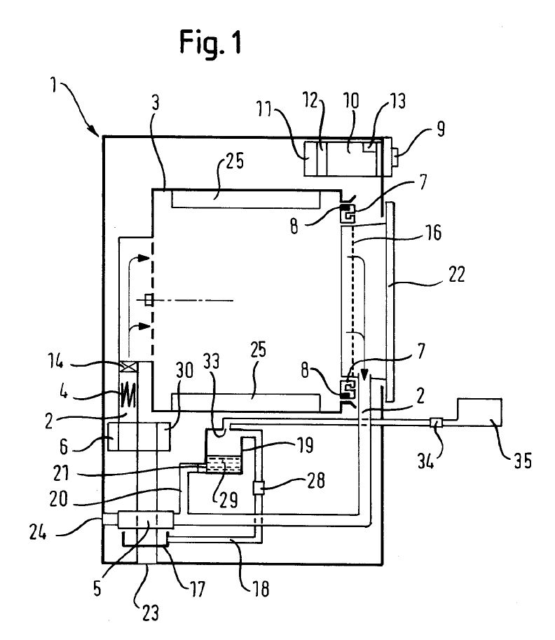

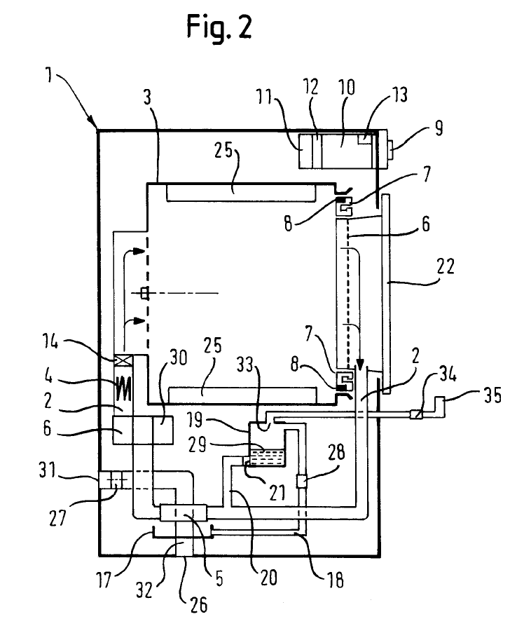

In FIGS. 1 and 2, the arrows show the flow direction of the process air.

The dryer 1 shown in FIG. 1 includes a drum as a drying chamber 3, rotatable about a horizontal axis, within which drive elements 25 are fastened for moving laundry when the drum rotates. Supply air is guided in the process air channel 2 by means of a fan 6 from the supply air inlet 23 via an air/air-heat exchanger 5 and an electrical heater 4 through the drum 3. Thus air heated by the electrical heater 4 from the rear, i.e. from a side of the drum 3 located opposite the door 22, is conducted through the perforated bottom thereof into the drum 3.

After exiting from the drum 3, the process air loaded with moisture is conducted in a part of the process air channel 2 denoted as the exhaust air channel, via the air/air-heat exchanger 5 to an exhaust air outlet 24. Thus the process air flows through the filling opening of the drum 3 to a lint filter 16 within a door 22 closing the filling opening. Subsequently, the process air flow in the door 22 is deflected downwards and forwarded to the air/air-heat exchanger 5. As a result of cooling, the moisture absorbed by the process air from the laundry items is condensed there and is collected in a condensate tank 17.

The condensate tank 17 is connected via a condensate channel 18, in which a pump 28 is located, to a rinsing container 19 in which a rinsing fluid 29 is located. The rinsing container 19 is additionally provided with a connection 33 to a water supply 35. Between the connection 33 and the water supply 35 a two-way valve 34 is located for controlling the water supply into the rinsing container 19. The rinsing container 19 comprises a lower container opening 21, and a cleaning line 20 is arranged between the rinsing container 19 and the air/air-heat exchanger 5.

The water supply 35 shown in FIG. 1 is, in particular, a water mains system of a building.

In this embodiment, in the supply air channel 2 a sensor 14 is located downstream of the heater 4 for the volumetric flow rate measurement. Thereby and by means of an evaluation unit 13 the total volumetric flow rate V of the process air is determined and a comparison carried out of said total volumetric flow rate with a volumetric flow rate limit Vₗᵢₘ. Based thereon, in the event of the soiling of the heat exchanger 5 the volumetric flow rate of the process air is reduced, and the cleaning process is triggered by the evaluation unit 13 when the total volumetric flow rate V falls below the volumetric flow rate limit Vₗᵢₘ. It is noteworthy that the positioning of the sensor 14 which is configured as a sensor 14 for volumetric flow rate measurement in the process air circuit is substantially insignificant. The positioning downstream of the heater 4 is, however, preferred as there the process air flow is substantially free of lint and similar, possibly damaging contaminants, and thus a reliable measurement may be anticipated in the long term.

As an alternative to the sensor 14 for a volumetric flow rate, a sensor 14 for temperature measurement is also considered, positioned at the denoted point. By means of this sensor 14, the evaluation unit 13 determines a temperature gradient ΔT of the process air and compares said temperature gradient with a temperature gradient limit ΔTₗᵢₘ. Based thereon, in the event of the soiling of the heat exchanger 5 with a reducing volumetric flow rate of the process air, the temperature thereof rising downstream of the heater 4, the cleaning process is triggered by the evaluation unit 13 when the temperature gradient ΔT exceeds the temperature gradient limit ΔTₗᵢₘ.

In the embodiment shown in FIG. 1, as a complement to the means for establishing a cleaning requirement of the air/air-heat exchanger 5, additionally a counter 11 for the number of drying cycles carried out, a clock 12 as well as a correspondingly programmed evaluation unit 13 are present. The elements are either part of the control device 10 of the condensation dryer 1 or associated therewith.

When the cleaning requirement has been established, a cleaning process is triggered by the control device 10 and/or the evaluation unit 13 in the embodiment shown in FIG. 1, in which the air/air-heat exchanger 5 is cleaned by means of a rinsing fluid 29 present in a storage container 19. The rinsing fluid 29 comprises in this case condensate, which was present previously in the air/air-heat exchanger 5 and has been pumped from a condensate tank 17 by means of a pump 28 via a condensate channel 18 into the storage container 19. For cleaning, the lower container opening 21 is opened and the rinsing fluid 29 is conducted through the cleaning line 20 into the air/air-heat exchanger 5. After passing through the air/air-heat exchanger 5, the rinsing fluid 29 is collected in the condensate tank 17 and pumped back into the rinsing receptacle 19. This cycle may be repeated, if required.

The drum 3 is mounted in the embodiment shown in FIG. 1 on the rear base by means of a rotary bearing and at the front by means of a bearing shield 16, the drum 3 bearing with a raised edge on the sliding strip 8 on the bearing shield 7, and thus being held at the front end. The control of the dryer takes place via a control device 10, which may be adjusted by the user via a control unit 9.

In the embodiment shown in FIG. 1, the fan 6 and the drum 3 are driven by the motor 30.

FIG. 2 shows a vertical section through a dryer which is designed as a circulating air dryer. In this embodiment, therefore, a supply air inlet and an exhaust air channel are not present. In contrast to the embodiment of FIG. 1, the cooling of the warm process air loaded with moisture from the drum 3 takes place in the air/air-heat exchanger 5 by heat exchange with cooling air in a cooling air channel 32. In the cooling air channel 32 is located a cooling fan 27 which conveys cooling air from a cooling air inlet 26 through the air/air-heat exchanger 5 to the cooling air outlet 31.

In the embodiment shown in FIG. 2 the determination of a cleaning requirement for the air/air-heat exchanger 5, as well as the cleaning thereof, takes place in particular by means of the sensor 14 as shown for FIG. 1. The parts of the condensation dryer not specifically explained for FIG. 2 thus correspond to the parts and the functions thereof disclosed for FIG. 1.

In the embodiment shown in FIG. 2, the fan 6, the cooling fan 27 and the drum 3 are driven by the same motor 30, the fan 6 and the cooling fan 27 being located on opposing sides of the motor 30.

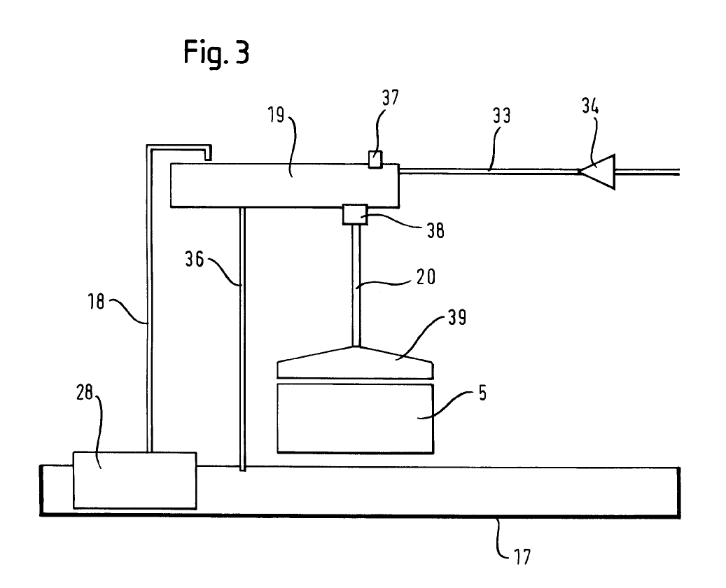

The cleaning device of the two dryers shown in FIGS. 1 and 2 is sketched in FIG. 3. In the heat exchanger 5, liquid condensate drips out of the process air which flows through and drips into the condensate tank 17. From there the pump 28 conveys it through the condensate channel 18 to the rinsing container 19 which, moreover, may also be removed after completing a drying cycle for the purpose of disposal of the condensate from the dryer. An emergency overflow 36 makes it possible for excess condensate to be able to pass back to the condensate tank 17, when the rinsing container 19 has been completely filled. Via a connection 33, in addition to the two-way valve 34, rinsing fluid which is possibly lacking may be supplied from a water supply 35 not shown here. By using a level switch 37, the necessary filling of the rinsing container 19 may be ensured.

If a cleaning process is required on the heat exchanger 5, the solenoid valve 38 on the rinsing container 19 is opened suddenly and rinsing fluid flows through the cleaning line 20 and the distributer 39 connected thereto over the heat exchanger 5, so that the heat exchanger is cleaned of adhering lint and other dirt. The rinsing fluid then reaches the condensate tank 17 and from there through the condensate channel 18—possibly by corresponding filtering for the purpose of removing carried along lint etc. may be conveyed back again to the rinsing container 19.

It is noteworthy that the heat exchanger 5 is not simply considered as an air/air-heat exchanger 5 but as representative of a heat exchanger 5 which is a component of a heat pump, in particular a heat sink of said heat pump. For the present relevant cleaning function and the soiling tendency of the heat exchanger 5 it does not essentially matter what happens with the heat which the heat exchanger 5 removes from the process air flowing through. In particular, it is not significant whether this heat ultimately leaves the dryer, as occurs in conventional condensation dryers, or whether it is recovered in any manner and, for example, returns to the drying process via the heater 4 designed as a heat source of the heat pump. In any case, the present new teaching provides a possibility for producing a dryer which is particularly user-friendly and operationally reliable.

What is claimed:

1. A condensation dryer comprising:
a drying chamber for objects to be dried;
a process air channel:
a heater in the process air channel for heating the process air;
a heat exchanger in the process air channel for cooling the process air after passing through the drying chamber;
a fan in the process air channel for conveying the process air;
a rinsing container connected to a water supply; and
a controller.

2. The condensation dryer of claim 1, further comprising a cleaning requirement identifier for the heat exchanger.

3. The condensation dryer of claim 2, wherein the cleaning requirement identifier comprises a counter that determines a number n of drying cycles already carried out and that compares the number n with a predetermined limit number nₗᵢₘ.

4. The condensation dryer of claim 2, wherein the cleaning requirement identifier comprises a clock that determines a total duration tₛᵤₘ of previously carried out drying cycles and compares them with a predetermined duration limit tₗᵢₘ.

5. The condensation dryer of claim 2, wherein the cleaning requirement identifier comprises an evaluator that determines a total quantity M of previously dried laundry items and that compares the total quantity M with a predetermined total quantity limit Mₗᵢₘ.

6. The condensation dryer of claim 2, wherein the cleaning requirement identifier comprises:
a volumetric flow rate sensor; and
an evaluator that determines a total volumetric flow rate V of the process air and compares said total volumetric flow rate with a volumetric flow rate limit Vₗᵢₘ, and that triggers a cleaning process when the total volumetric flow rate V falls below the volumetric flow rate limit Vₗᵢₘ.

7. The condensation dryer of claim 2, wherein the cleaning requirement identifier comprises:
a temperature sensor; and
an evaluator that that determines a temperature gradient ΔT of the process air and compares said temperature gradient with a temperature gradient limit ΔTₗᵢₘ, and that triggers a cleaning process when the temperature gradient ΔT exceeds the temperature gradient limit ΔTₗᵢₘ.

8. The condensation dryer of claim 2, further comprising an acoustic and/or optical display that displays the cleaning requirement.

9. The condensation dryer of claim 1, wherein the rinsing container comprises a lower container opening and, wherein the dryer further comprises a cleaning line between the heat exchanger and the rinsing container.

10. The condensation dryer of claim 1, wherein the rinsing container is connected to a condensate tank via a condensate channel in which a condensate pump is located.

11. The condensation dryer of claim 1, further comprising an air/air-heat exchanger or a heat sink of a heat pump in the process air channel.

12. A method for operating a condensation dryer that includes a drying chamber for objects to be dried, a process air channel, a heater in the process air channel for heating the process air, a heat exchanger in the process air channel for cooling the process air after passing through the drying chamber, a fan in the process air channel for conveying the process air, a rinsing container connected to a water supply, and a controller, the method comprising cleaning the heat exchanger with a predetermined quantity of rinsing fluid.

13. The method of claim 12, wherein the condensation dryer further comprises a cleaning requirement identifier for the heat exchanger, the method further comprising determining a cleaning requirement for the heat exchanger with a cleaning requirement identifier.

14. The method of claim 13, wherein the determining of the cleaning requirement comprises:
determining an operating measure U;
comparing the operating measure with a predetermined value Uₗᵢₘ, and establish the cleaning requirement when Uₗᵢₘ=U.

15. The method of claim 14, further comprising displaying the cleaning requirement acoustically and/or optically.

16. The method of claim 14, further comprising determining a required quantity of rinsing fluid based upon a predetermined cleaning program.

17. The method of claim 16, wherein determining the predetermined quantity of rinsing fluid comprises:
determining a quantity of rinsing fluid in the rinsing container; and
topping up the rinsing container with rinsing fluid when the quantity of rinsing fluid in the rinsing container falls below the required quantity with water from the water supply.

18. The method of claim 12, wherein the rinsing fluid comprises condensate.

19. The method of claim 18, further comprising:
collecting the rinsing fluid in a condensate tank; and
pumping back into the rinsing container.
